(19) United States
(12) Patent Application Publication
(10) Pub. No.: US 2018/0345296 A1
(43) Pub. Date: Dec. 6, 2018

(54) AIR PURIFIER

(71) Applicant: Seawise Ionization Technology Limited, Hong Kong (CN)

(72) Inventors: Wai Sun WONG, Hong Kong (CN); Stanley WEINBERG, Los Angeles, CA (US)

(21) Appl. No.: 15/838,788

(22) Filed: Dec. 12, 2017

(30) Foreign Application Priority Data
Jun. 1, 2017 (HK) 17105470.9

(51) Int. Cl. B03C 3/155; B03C 3/41

(52) U.S. Cl. CPC B03C 3/155; B03C 3/41

(57) ABSTRACT

The utility model provides an air purifier. The air purifier comprises a positive ion generation module, a first airflow filter screen and a second airflow filter screen, wherein the positive ion generation module is mounted between the first airflow filter screen and the second airflow filter screen. The beneficial effects of the air purifier of the utility model are that particles as small as 0.3 microns in air can be filtered out, completely-silent operation can be achieved in a sleeping environment, three operation modes can be selected, a large purification system can be executed with the minimum size, and positive ions are generated to replace negative ions.

### BACKGROUND OF THE UTILITY MODEL

### Technical Field

The utility model relates to air filter devices, in particular to an air purifier.

### Description of Related Art

Various existing air purifiers generally adopt traditional high efficiency particulate air (HEPA) filters. HEPA filters capture particles in air into fiber pads and have been used for decades. In addition, purifiers adopting air ionizers are also available. The air ionizers operate to make air molecules carry electric charges, and thus the air molecules can adhere to particles in air. Theoretically, undesired particles can be collected in the filters of the purifiers upon adhesion of the air molecules to the collection plates. However, traces of ozone can be released into air by the purifiers.

HEPA filters are one of the most widely-used filters. Extremely fine fabric physical barriers are adopted by HEPA filters to capture almost all particles passing through HEPA filters. HEPA filters can remove almost all particulate matter and has an extremely good effect; however, HEPA filters cannot remove most gaseous pollutants and cannot remove microorganism particles such as bacteria or certain mold spores.

Domestic air filters of another type are called ionic filters. Air is sucked by means of fans through a system for charging particles passing through equipment, then the charged particles are attracted to pass through a metal plate with opposite electric charges, and finally the particles adhere to the metal plate and are removed from air. The system is extremely high in efficiency. Filters and the metal plate can be easily removed, cleaned and reinstalled.

The main defects of the prior art:

HEPA filters have the main defects that the replacement cost of the filters is generally extremely high, and two to five HEPA filters may be required each time for the best purifier models; in addition, noise can be generated by some air purifiers using HEPA filter systems depending on the model. Certain HEPA filter systems are extremely noisy.

The ionic air purifiers have the defect that particles, particularly microorganisms such as bacteria, only adhere to the metal plates instead of being destroyed, so the filters have to be cleaned extremely carefully.

A disputable issue about the ionic air purifiers is ozone generation. Certain ionic air purifiers can generate a small amount of ozone that is a lung irritant. For people who suffer from severe dyspnea, the ionic filters can worsen certain symptoms. However, the issue is still disputable.

### BRIEF SUMMARY OF THE UTILITY MODEL

An air purifier is provided by the utility model and comprises a positive ion generation module, a first airflow filter screen and a second airflow filter screen, wherein the positive ion generation module is mounted between the first airflow filter screen and the second airflow filter screen.

As a further improvement of the utility model, the positive ion generation module comprises an ionizer, tungsten filaments and a metal net, and the ionizer is connected with the tungsten filaments.

As a further improvement of the utility model, the positive ion generation module further comprises an ion voltage multiplier, and the ion voltage multiplier is connected with the tungsten filaments.

As a further improvement of the utility model, the metal net is made of stainless steel.

As a further improvement of the utility model, the outer surface of the metal net is coated with a non-viscous coating.

As a further improvement of the utility model, the air purifier further comprises a filter, and the filter is mounted on the outer side of the second airflow filter screen.

As a further improvement of the utility model, the air purifier further comprises fans, and the fans are mounted between the first airflow filter screen and the second airflow filter screen.

As a further improvement of the utility model, the number of the fans is four, and the four fans include the first fan, the second fan, the third fan and the fourth fan.

As a further improvement of the utility model, the air purifier further comprises a carbon fiber brush, and the carbon fiber brush has the high voltage of −10KV so as to generate negative ions.

As a further improvement of the utility model, the air purifier further comprises a mode selection switch used for controlling the fans.

The beneficial effects of the air purifier of the utility model are that particles as small as 0.3 microns in air can be filtered out, completely-silent operation can be achieved in a sleeping environment, three operation modes can be selected, a large purification system can be executed with the minimum size, and positive ions are generated to replace negative ions.

### BRIEF DESCRIPTION OF THE SEVERAL VIEWS OF THE DRAWINGS

FIG. 1 is a sectional view of an air purifier of the utility mode seen from the side view;

FIG. 2 is an internal view of the utility model seen from the front view; and

FIG. 3 is another internal view the utility model seen from the front view under the condition that fans and a metal grating are dismounted.

### DETAILED DESCRIPTION OF THE UTILITY MODEL

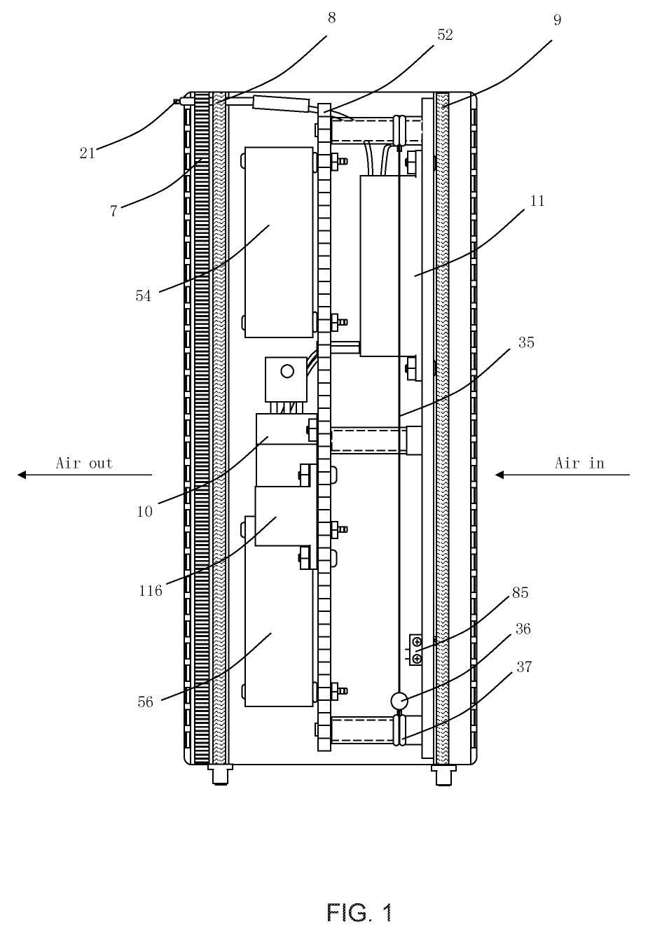

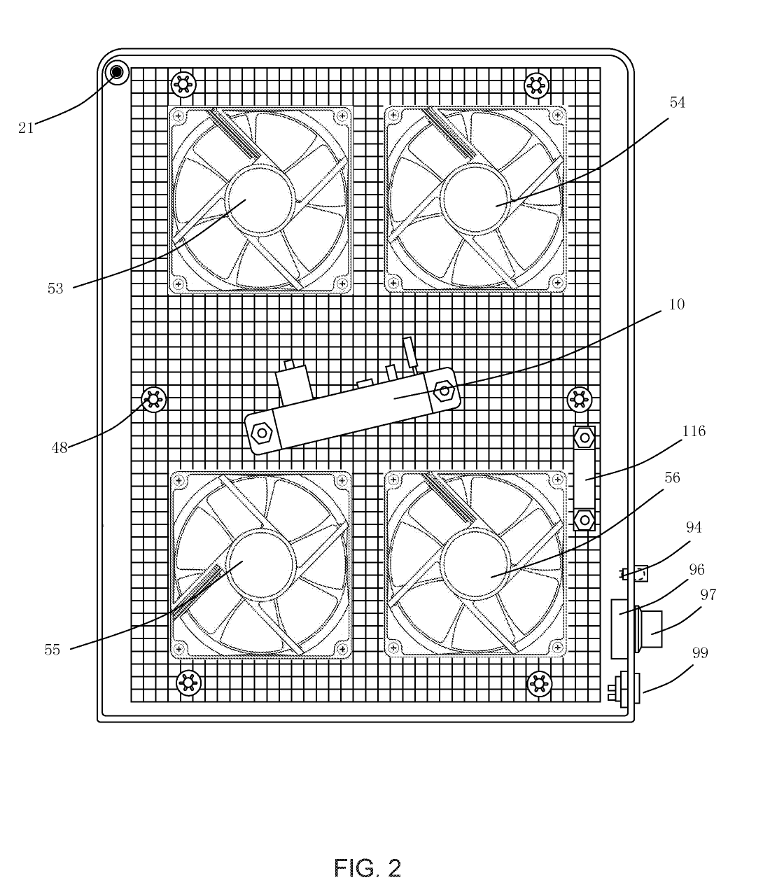

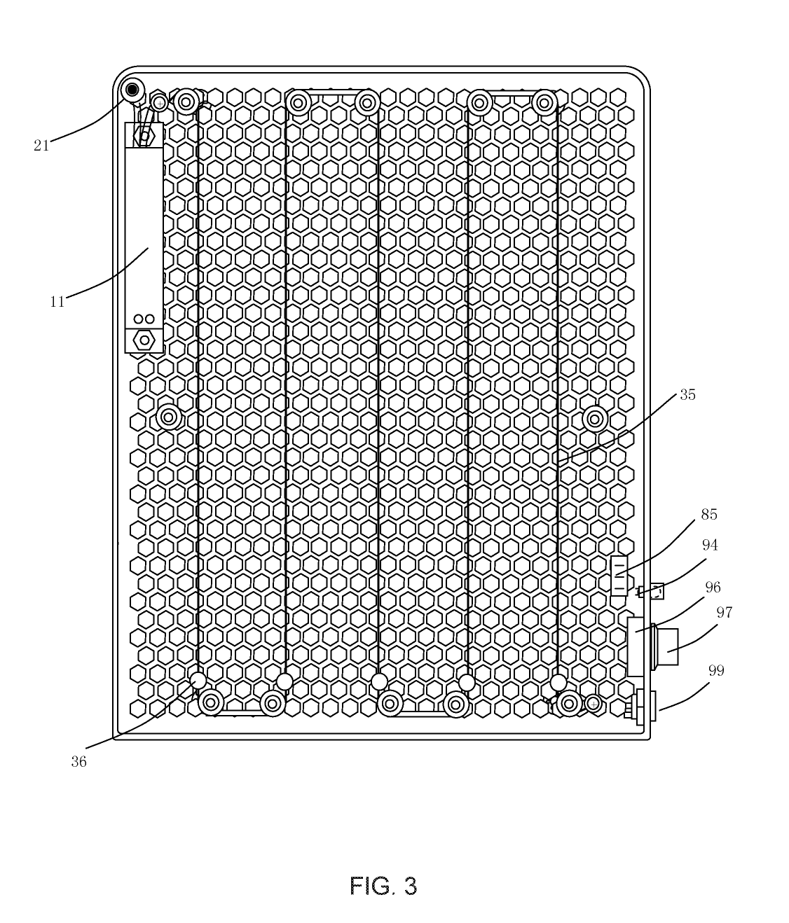

As is shown in FIGS. 1-3, an air purifier is disclosed by the utility model and comprises a positive ion generation module, a first airflow filter screen 9 and a second airflow filter screen 8, wherein the positive ion generation module is mounted between the first airflow filter screen 9 and the second airflow filter screen 8.

The positive ion generation module comprises an ionizer 10, tungsten filaments 35 and a metal net 52, and the ionizer 10 is connected with the tungsten filaments 35.

The positive ion generation module further comprises an ion voltage multiplier 11, and the ion voltage multiplier 11 is connected with the tungsten filaments 35.

The metal net 52 is made of stainless steel.

The outer surface of the metal net 52 is coated with a non-viscous coating, and thus dust or tar can be prevented from adhering to the metal net 52.

The air purifier further comprises a filter 7, and the filter 7 is mounted on the outer side of the second airflow filter screen 8.

The air purifier further comprises fans, and the fans are mounted between the first airflow filter screen 9 and the second airflow filter screen 8.

The number of the fans is four, and the four fans include the first fan 53, the second fan 54, the third fan 55 and the fourth fan 56.

The air purifier further comprises a carbon fiber brush 21, and the carbon fiber brush 21 has the high voltage of −10 KV so as to generate negative ions.

The air purifier further comprises a mode selection switch 97 used for controlling the fans.

Positive ions are generated by the tungsten filaments 35 at a +18 KV high-voltage position and flows towards a grounding plane or the metal net 52, airflow can be generated along with flowing of the positive ions, and air is driven to pass through the first airflow filter screen 9 with static electricity. Filtered air passes through the positive ions and then passes through the metal net 52. Afterwards, the filtered air passes through the second airflow filter screen 8 and then passes through the filter 7.

The air purifier has four modes, namely, the mode that the air purifier is off, the mode that the ionizer is on, the mode that the ionizer is on with the fans on at a low speed, and the mode that the ionizer is on with the fans on at a high speed.

The first airflow filter screen 9 and the second airflow filter 8 are 3M high-airflow filter (HAF) screens, and the filter screens can be electronically activated when the air purifier is switched on. Air-borne contaminants as small as 0.3 microns can be filtered out through the HAF screens. The filter 7 is an ozone-formaldehyde-VOC decomposition filter. The tungsten filaments 35 are the key component of the air purifier, have the high voltage of +18 KV and generate positive ion airflow through the grounded metal net 52. The airflow rate can be increased easily through the first fan 53, the second fan 54, the third fan 55 and the fourth fan 56, so that better performance is achieved, and a high wind speed or a low wind speed can be provided for selection. A completely-silent sleeping mode can be provided through a setting for turning off the fans.

Since the tungsten filament 35 generate a large quantity of positive ions, and it is possible that excessive positive ions exist around an outer plastic shell. The carbon fiber brush 21 can generate negative ions with the high voltage of −10 KV, the positive ions near the outer plastic shell can be neutralized by the negative ions, and the effect of blackening the wall caused by excessive generation of the positive ions is relieved.

The air purifier further comprises screw washers 48, a voltage reduction module 116, an LED blue lamp 94 with the dimension of 5 mm, a switch protective cover 96, a direct-current socket 99 with the dimension of 2.1 mm, a microswitch 85, glass beads 36 and a silica gel ring 37.

18V direct current is input to the air purifier, and the maximum current input value is 2 A. Three or four preset settings or operating modes, such as the off-mode, the silent mode and the low wind speed and/or high wind speed mode, can be available for the wind speeds of the fans of the air purifier.

According to the air purifier, ions generated by the ionizer drive airflow for air purification, and air-borne contaminants which are as small as 0.3 microns are captured through the electronically-activated high-airflow filter (HAF) screens.

The air purifier can provide the completely silent fan mode, the high wind speed fan mode and the low wind speed fan mode for selection and is unique on the market.

In addition, the ozone restraining technique is adopted, so that positive ions can be generated to replace negative ions when the positive ions are generated, and generation of ozone is restrained. The ozone content is further decreased through the ozone decomposition screen.

The first airflow filter screen 9 and the second airflow filter screen 8 can be replaced easily, and thus the air purifier can be repaired and maintained conveniently and rapidly.

In conclusion, particles as small as 0.3 microns in air can be filtered out through the air purifier, completely-silent operation can be achieved in a sleeping environment, three operation modes can be selected, a large purification system can be executed with a small size, and positive ions are generated to replace negative ions.

The above content is a further detailed description of the utility model with respect to the preferred embodiment, but specific embodiments of the utility model are not only limited to the above description only. Various simple derivatives or substitutes that can be made by those skilled in the technical field of the utility model without deviating from the concept of the utility mode are all within the protection scope of the utility model.

1. An air purifier, wherein a positive ion generation module, a first airflow filter screen and a second airflow filter screen, wherein the positive ion generation module is mounted between the first airflow filter screen and the second airflow filter screen.

2. The air purifier according to claim 1, wherein the positive ion generation module comprises an ionizer, tungsten filaments and a metal net, and the ionizer is connected with the tungsten filaments.

3. The air purifier according to claim 2, wherein the positive ion generation module further comprises an ion voltage multiplier, and the ion voltage multiplier is connected with the tungsten filaments.

4. The air purifier according to claim 2, wherein the metal net is made of stainless steel.

5. The air purifier according to claim 4, wherein the outer surface of the metal net is coated with a non-viscous coating.

6. The air purifier according to claim 1, wherein the air purifier further comprises a filter, and the filter is mounted on the outer side of the second airflow filter screen.

7. The air purifier according to claim 6, wherein the air purifier further comprises fans, and the fans are mounted between the first airflow filter screen and the second airflow filter screen.

8. The air purifier according to claim 7, wherein the number of the fans is four, and the four fans include the first fan, the second fan, the third fan and the fourth fan.

9. The air purifier according to claim 8, wherein the air purifier further comprises a carbon fiber brush, and the carbon fiber brush has the high voltage of −10 KV so as to generate negative ions.

10. The air purifier according to claim 8, wherein the air purifier further comprises a mode selection switch used for controlling the fans.
